(19) United States
(12) Patent Application Publication
(10) Pub. No.: US 2026/0329879 A1
(43) Pub. Date: Oct. 22, 2026

(54) SYSTEMS AND METHODS OF PROXIMITY-BASED AUGMENTATION FOR DATASETS

(71) Applicants: Kantar UK Limited, London (GB); FIREFLY MARKET RESEAARCH INDIA PRIVATE LIMITED, Chennai (IN)

(72) Inventors: Kalidas ASHOK, Chennai (IN); Renganathan VALLINAYAGAM, Chennai (IN); Roshni ADDA, Chennai (IN); Horacio González Duhart Muñoz DE COTE, London (GB); Luz Piedad Narváez ORTIZ, London (GB); Vijay Kumar GUNDAPUNEEDI, Chennai (IN); Roudranil DAS, Chennai (IN); Pratik BOSE, London (GB); Divyaa Lakshmanan RAMALAKSHMI, Chennai (IN); Dibu John PHILIP, Chennai (IN)

(73) Assignees: Kantar UK Limited, London (GB); FIREFLY MARKET RESEAARCH INDIA PRIVATE LIMITED, Chennai (IN)

(21) Appl. No.: 19/468,506

(22) Filed: Feb. 3, 2026

(30) Foreign Application Priority Data
Feb. 7, 2025 (IN) 20251010214

(51) Int. Cl. G06F 16/248; G06F 16/2458

(52) U.S. Cl. CPC G06F 16/248; G06F 16/2477

(57) ABSTRACT

Proximity-based augmentation is provided. A method includes identifying a first class of data elements in a data lake satisfying a criterion. The method includes identifying a second class of data elements in the data lake which fail to satisfy the criterion. The method includes identifying subsets for the second class of data elements, each of the subsets corresponding to the first class according to a different value of a metric. The method includes generating, for the plurality of subsets a function of the metric. The method includes determining a representative value for a centroid of the first class of data elements different from an algebraic mean for the centroid, using the different value of the metric for each of the plurality of subsets of the second class of data elements.

### CROSS REFERENCE TO RELATED APPLICATIONS

This application claims the benefit of, and priority to, Indian Provisional Patent Application No. 202541010214 filed Feb. 7, 2025, the entirety of which is incorporated by reference herein.

### BACKGROUND

Databases can include correlated data. For example, a database can include time-series data including correlation between or within the times of the time-series.

### SUMMARY OF THE INVENTION

Computational systems can access large quantities of data elements, which can be arranged into time-series data sets. Various classes of these data elements can be used for certain functions (e.g., deterministic functions). For example, weather forecasting models can include a database of previous weather data for a cell of interest, and weather data for cells adjoining the cell of interest, as can be useful for predefined forecasting functions. However, such techniques can omit additional useful data included in non-adjacent cells. For example, data in (and trends between) further cells can provide additional predictive power. Although increasing a cell window size can incorporate additional available data elements, the larger cells can diminish in predictive power, as they include data elements more distal from the cell of interest, and can further degrade a determination of trends between smaller cells, as can be predictive for a cell of interest.

References to weather prediction should not be construed as limiting; systems and methods of the present disclosure can prove useful in various datasets. For example, a phase space of a spatial domain of a weather forecast can be substituted for further state spaces. Accordingly, implementations of the systems and methods of the present disclosure can be used to augment datasets for business intelligence, customer analytics, epidemiological forecasts, fraud detection, and so forth. For example, some examples of the present disclosure are provided with regard to an example of time-series survey questions related to a survey cohort. Like the weather prediction example, such an example can include a time-series relationship, as well as further dimensional relationships present in various data elements.

The disclosed solutions have technical advantages for computing devices. For example, the data processing system can reduce energy usage relative to other approaches. Moreover, systems and methods of the present disclosure can resolve deterministically, as can avoid certain stochastic errors. Although machine learning approaches can identify some structural relationships within a data structure, such an approach can use substantial computational resources, and can further lead to widely varying processing times. Conversely, a deterministic closed form solution can reduce computational resources, and lower the mean and variance of the computation time, which can aid in the presentation of data (e.g., via a dashboard) or in a pipeline or other schedule-based operation of computational resources.

At least one aspect is directed to a method. The method includes identifying in a data lake, by one or more processors, a first class of data elements satisfying a criterion. The method includes identifying in the data lake, by the one or more processors, a second class of data elements which fail to satisfy the criterion. The method includes identifying, by the one or more processors, for the second class of data elements, a plurality of subsets, each of the plurality of subsets corresponding to the first class according to a different value of a metric. The method includes generating for the plurality of subsets, by the one or more processors, a function of the metric. The method includes determining, by the one or more processors, a representative value for a centroid of the first class of data elements different from an algebraic mean for the centroid, using the different value of the metric for each of the plurality of subsets of the second class of data elements.

In some aspects, the metric includes a temporal distance between the second class of data elements and the first class of data elements.

In some aspects, the representative value is determined based on the first class of data elements.

In some aspects, the second class of data elements are identified based on a linear relationship to the first class of data elements, wherein a curve of the linear relationship terminates at the first class of data elements.

In some aspects, the second class of data elements are identified based on a linear relationship to the first class of data elements, wherein a curve for the second class of data elements extends through the first class of data elements in two directions.

In some aspects, the first class of data elements corresponds to a first cohort population. The second class of data elements can correspond to a second cohort population, different from the first cohort population. The representative value can include a behavioral prediction for the first cohort population.

In some aspects, the first class of data elements corresponds to a first input of a cohort population and the second class of data elements corresponds to a second input of the cohort population.

In some aspects, the method includes comparing, by the one or more processors, a quantity of the first class of data elements to a first threshold. The method can include determining, by the one or more processors, the representative value based on the comparison.

In some aspects, the method includes presenting by the one or more processors, via a user interface, an indication of asynchronous state data. The method can include receiving, by the one or more processors, from the user interface, an indication to generate the representative value using the asynchronous state data. The method can include generating the representative value by the one or more processors responsive to the receipt of the indication to generate the representative value.

In some aspects, the method includes determining, by the one or more processors, an initial state of a latent variable of the representative value and a variance thereof. The method can include determining, by the one or more processors, the representative value at a time of time-series data using the initial state.

In some aspects, the first class of data elements include data elements for an nth time of time-series data and the second class of data elements includes time-series data for a plurality of times preceding the nth time.

In some aspects, the first class of data elements include data elements for an nth time of time-series data and the second class of data elements includes time-series data for the nth time.

At least one aspect is directed to a system. The system includes a data processing system including one or more processors coupled with memory. The data processing system can identify, in a data lake, a first class of data elements satisfying a criterion. The data processing system can identify, in the data lake, a second class of data elements which fail to satisfy the criterion. The data processing system can identify, for the second class of data elements, a plurality of subsets, each of the plurality of subsets corresponding to the first class according to a different value of a metric. The data processing system can generate, for the plurality of subsets, a function of the metric. The data processing system can determine a representative value for a centroid of the first class of data elements different from an algebraic mean for the centroid, using the different value of the metric for each of the plurality of subsets of the second class of data elements and the first class of data elements; and present, via a graphical user interface, the representative value.

In some aspects, the metric includes a temporal distance between the second class of data elements and the first class of data elements.

In some aspects, the first class of data elements corresponds to a first cohort population and the second class of data elements corresponds to a second cohort population, different from the first cohort population.

In some aspects, the data processing system can present, via a user interface, an indication of asynchronous state data. The data processing system can receive, from the user interface, an indication to generate the representative value using the asynchronous state data. The data processing system can generate the representative value responsive to the receipt of the indication to generate the representative value.

At least one aspect is directed to a computer-readable medium including instructions, which, when executed by one or more processors, cause the one or more processors to perform operations. The instructions include instructions to present, via a graphical user interface, an indication of an availability of asynchronous state data. The instructions include instructions to receive, from the graphical user interface, an indication to generate a representative value using the asynchronous state data. The instructions include instructions to, responsive to the receipt of the indication: identify, in a data lake, a first class of data elements satisfying a criterion; identify, in the data lake, a second class of data elements which fail to satisfy the criterion; identify, for the second class of data elements, a plurality of subsets, each of the plurality of subsets corresponding to the first class according to a different value of a metric; generating for the plurality of subsets, a function of the metric; and determine a representative value for a centroid of the first class of data elements different from an algebraic mean for the centroid, using the different value of the metric for each of the plurality of subsets of the second class of data elements and the first class of data elements. The instructions include instructions to present, via the graphical user interface, the representative value.

In some aspects, the metric includes a temporal distance between the second class of data elements and the first class of data elements.

In some aspects, the first class of data elements corresponds to a first cohort population and the second class of data elements corresponds to a second cohort population, different from the first cohort population.

In some aspects, the instructions include instructions to present, via a user interface, an indication of asynchronous state data. The instructions can include instructions to receive, from the user interface, an indication to generate the representative value using the asynchronous state data. The instructions can include instructions to generate the representative value responsive to the receipt of the indication to generate the representative value.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example data processing system, in accordance with some aspects;

FIG. 2 depicts a dataflow for the data processing system of FIG. 1, in accordance with some aspects;

FIG. 3 depicts an example of time-series data elements related to various cohorts and a time-series sequence, in accordance with some aspects;

FIG. 4 is a dataflow for an example method, according to some aspects;

FIG. 5 is a block diagram illustrating an architecture for a computer system that can be employed to implement elements of the systems and methods described and illustrated herein;

FIG. 6 depicts an example of a graphical user interface (GUI) generated or presented, according to some aspects.

### DETAILED DESCRIPTION

Following below are more detailed descriptions of various concepts related to, and implementations of, methods, apparatuses, and systems of proximity-based augmentation for datasets. The various concepts introduced above and discussed in greater detail below can be implemented in any of numerous ways.

Various data elements of interest can be classified as a first class of data elements. For time-series data (e.g., a sequence of surveys), one of various times can be identified as a time of interest. For example, a most recent time can be selected as a time of interest, such that other times are provided as preceding the time of interest. Moreover, the first class of data elements can include a subset of the time-series data of the most recent time. For example, the classified data elements can be specific to a cohort. For example, each time can include survey data for various user demographics, such that when considering one demographic, data received from other demographics can be excluded from the first class. Further still, a subset of the survey data may be of interest. For example, to determine an affinity or trust of a brand, a question regarding brand trust can be of the first class, wherein a question about value or pricing can be otherwise classified.

Proximity-based augmentation can refer to or include augmenting the first class of data elements with further data elements of the repository, based on a logical proximity thereto. The logical proximity can refer to various measures of proximity. A measure of proximity can include temporal proximity (e.g., an adjacent time of time-series data can be more predictive than a distal time of the time-series). A measure of proximity can include cohort proximity (e.g., similar cohorts, such as persons aged 18-24 and 25-30 can exhibit similar preferences). However, such an example can omit additional information, as can be provided from other cohorts. For example, other age groups (beyond 25-30) can provide information which is further predictive of the persons aged 18-24 according to either of a positive or negative correlation. A measure of proximity can include data element proximity. For example, referring to the example survey questions, a response regarding brand trust can be predictive of another response related to brand safety.

According to the present disclosure, states for classified data elements are related to previous states of the data elements, as well as related cohorts or other related data elements. Accordingly, based on a logical proximity (e.g., predictive relationship) between two times, cohorts, or other organizations of data elements, a statistical strength of the first class of data elements can be augmented. For example, a sample size of ten can be provided for a classified cohort at a time of time-series data, for a response to a question of a survey. Such a sample size can provide limited statistical power. For example, a mean or other centroid value of the sample can deviate from a representative value. However, by using logically proximal data, the statistical power can be augmented to reduce a distance between the representative value and a ground truth. The logically proximal data can (but need not) correspond to contiguously related data elements. For example, although in some cases, persons aged 18-24 are logically proximal to persons aged 25-30, in some cases, persons aged 65-70 are more proximal to an 18-24-year-old cohort than the persons aged 25-30. Similarly, adjacent times need not be logically proximal (e.g., according to seasonal effects, a time period one year ago can be more logically proximal than a prior month).

As described herein, logical proximity of various data elements can be determined to aid in the generation of a representative value based on data elements which are classified as a part of a sample and other data which is not a part of that class. Moreover, the systems and methods provided herein can be implemented for use with a dashboard or other user interface, as can include pre-completion of higher latency tasks, such that latency between user selections and presentation of representative values can be reduced (e.g., to achieve real-time or near-real time operation).

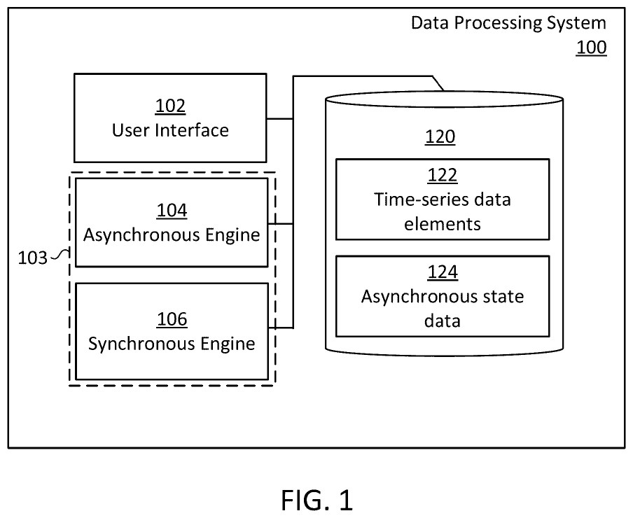

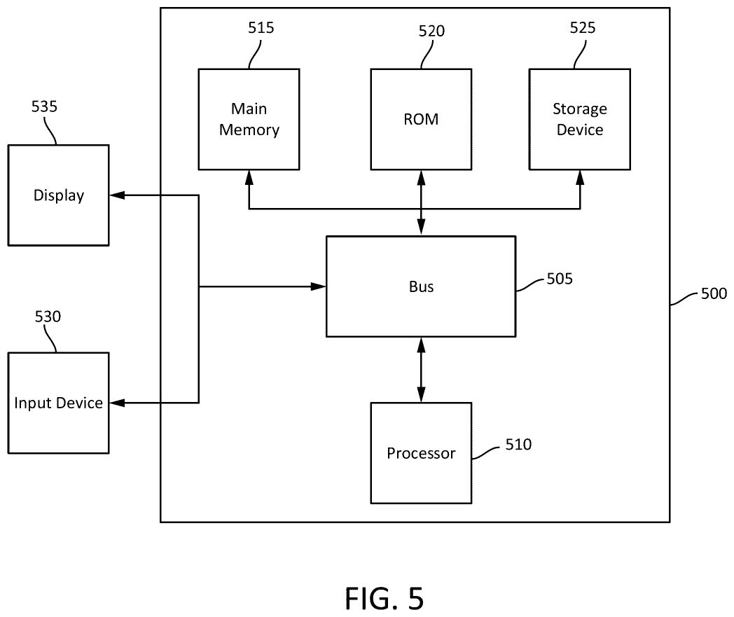

FIG. 1 depicts a data processing system 100, in accordance with some aspects. The data processing system 100 can include or interface with at least one user interface 102, asynchronous engine 104, synchronous engine 106, or data repository 120. The user interface 102, asynchronous engine 104, or synchronous engine 106 can each include at least one processing unit or other logic device such as a programmable logic array engine, or module configured to communicate with the data repository 120 or database. The user interface 102, asynchronous engine 104, synchronous engine 106, or data repository 120 can be separate components, a single component, or part of the data processing system 100. The data processing system 100 can include hardware elements, such as one or more processors, logic devices, or circuits. For example, the data processing system 100 can include one or more components or structures of functionality of computing devices depicted in FIG. 5.

The data repository 120 can include one or more local or distributed databases, and can include a database management system. The data repository 120 can be configured to receive updated data elements. These updates can be received incident to subsequent times of a time-series event. The data repository 120 can include computer data storage or memory and can store one or more of time-series data elements 122, or asynchronous state data 124. Additionally, the data repository 120 can store any of the thresholds, criteria, user inputs, or other information referred to herein.

The time-series data elements 122 can refer to or include any received data elements provided according to a time-series organization. The time-series organization can refer to periodic sequences, triggered sequences, “ticks” of a forecasting model, or so forth. Periodic sequences can include annual, quarterly, monthly, daily, or other periods (e.g., periodic surveys). Triggered sequences can include event-based generation of data elements as can be related to product launches, public relations campaigns, or other activities. Ticks of a forecasting model can refer to a time-sequence which is fixed according to a simulation time, or a step of a computational loop.

The time-series data elements 122 are sometimes referred to, collectively, as a data lake. Such a nomenclature is not intended to imply a lack of structure for the stored data. For example, a data lake can include a centralized or distributed repository that can store structured or unstructured data for analytical processing. Various data elements 122 of the data lake can be stored with reference to a time-series related to the data elements 122 (e.g., a time of the time-series at which the data elements were captured or generated). For example, the data elements 122 can be structured as a table, relational database, or other structure. However, a data structure can omit certain indications of logical proximity. For example, a data structure may not include a probabilistic indication of how one survey question relates to another, even where such a relationship is present. The data elements 122 can further be structured according to an associated cohort. For example, a cohort can refer to or include a person (e.g., survey respondent) or category thereof. The cohort can be organized according to a name, advertising identifier, demographic information (e.g., males aged 18-40), or so forth.

The asynchronous state data 124 can refer to or include initial values describing a relationship between various of the time-series data elements 122. For example, the initial values can include an estimate of a latent variable, x. This variable can describe an initial condition, such as a survey response at a first time of time-series data element 122. This variable may be provided as a vector having an initial state, xo. Such an initial state, like other initial conditions or other data, may refer to estimated values as may vary somewhat from a ground truth (e.g., the latent variable for all of a cohort, including un-surveyed cohort members). The asynchronous state data 124 can include additional indications of the latent variable for subsequent times of a time-series prior to a selected time. An initial variance of the latent variable (P) can be determined based on the initial state, xo. This variance may be generalized as a function of x, as based on further time-series data. Further, error variances Qₜ and Rₜ may be determined as a part of the asynchronous state data 124. Additional details as to the determination of x₀, Pₜ, Qₜ, and Rₜ are further described with regard to the asynchronous engine 104.

The data processing system 100 can include at least one user interface 102 designed, constructed, or operational to convey information between the data processing system 100 and a user. The user interface 102 can include or interface with a graphical user interface (GUI) on a touchscreen or other display. The user interface 102 can include or interface with a user entry device such as a touchscreen, keyboard, API, or a web interface.

The data processing system 100 can include at least one augmentation engine 103 configured to augment data elements 122 of a selected time (sometimes referred to as a time of interest) for a selected cohort (sometimes referred to as a cohort of interest). Unlike synthetic data approaches, the data augmentation of the augmentation engine 103 need not generate synthetic data elements 122. Instead, the augmentation engine 103 can augment an average or other centroid of data elements 122 using additional data elements 122 from other times or other cohorts. Accordingly, the present methods can be performed deterministically. The augmentation engine 103 is depicted as including an asynchronous engine 104 and a synchronous engine 106, as can be referred to as executing separate (sub) operations of data augmentation. Such a division and nomenclature should not be construed as limiting, and is provided to correspond to a method of use where an asynchronous engine 104 executes computationally expensive operations as a scheduled or background operation (to generate asynchronous data 124) and the asynchronous data 124 is used synchronously with a user interface 102 (which is sometimes referred to as a dashboard, control panel, or so forth).

The data processing system 100 can include at least one asynchronous engine 104 designed, constructed, or operational to generate asynchronous state data 124. The asynchronous state data 124 can refer to a latent variable, x (e.g., a survey response value for a survey of interest). The asynchronous engine 104 can operate asynchronously to a receipt of a selection from the user interface 102. For example, the operations of the asynchronous engine 104 can use substantial computational resources, such that it can be advantageous to execute a scheduled or background process to determine asynchronous state data 124 prior to display via the user interface 102. However, this asynchronous nomenclature should not be construed as limiting. In some instances, the asynchronous engine 104 can operate responsive to a request or display of information. For example, a user can select a cohort for which asynchronous state data 124 is not pre-determined. Upon such a selection, the data processing system 100 can cause the asynchronous engine 104 to determine the asynchronous state data 124 synchronously to its selection. In some cases, such execution can lead to substantial latency prior to a display of an estimated latent variable. Accordingly, the user interface 102 can be configured to present an indication of an availability or unavailability of the asynchronous state data 124. Moreover, for some computational systems, operation can operate more quickly, such that the data processing system can operate with acceptable latently without invoking separate asynchronous operations to pre-cache asynchronous state data 124.

The latent variable, x can be referred to as a vector (x) having a first component which can be described as a function of time (t) for a cohort of interest (c): (x_{ct}). A second component can be described as a function of time for all other cohorts of the data set (c*): (x_{c*t}). This is illustrative and there could be more than two components, where the first component might refer to the cohort of interest and each of one or more further components can refer to a different cohort or combination of cohorts as a function of time or various cohort characteristics. Where multiple time instances of a time-series are available, the latent variable (x) can be described relative to prior instance of the variable. That is, xₜ=Fₜxₜ₋₁, where F can be provided (sometimes but not always) as an identity matrix for all times of the time-series. A further error term, w, can also be time-variant and be provided as a vector (wₜ) including a first component which corresponds to the cohort of interest and time and a second component which corresponds to the other cohorts and time. Accordingly, xₜ can be further described by xₜ=Fₜxₜ₋₁+wₜ (where F is provided as a 2×2 matrix), and x and w are provided as 2×1 vectors. These dimensions are again illustrative based on the dimension of x.

A measurement vector (z) can vary somewhat from the latent variable (x). For example, while a latent variable can refer to a underlying trait of a cohort population (including un-surveyed members), such data is not generally available. However, related data, such as survey responses for a subset of that cohort population, z, may be available. Like x, z can be depicted as a vector having a first component as a function of time for the cohort of interest, s_{ct} and a second component as a function of time for cohorts other than the cohort of interest, s_{c*t}. As with x, these dimensions are illustrative and instead of just a single “second” component, we could have several components-one each for a different cohort. Further, an error term v, can define an error between z and x, such that zₜ=Hₜxₜ+vₜ (where Iₜ is provided, for example, as a 2×2 identity matrix). A variance of the error can be provided as a matrix, Rₜ. Moreover, x_{c*t} can include information used to determine x_{ct} according to a statistical relationship therebetween. For example, the relationship can include a time invariant offset, α, scalar term, β, for x_{c*t}, and a stochastic term ϵₜ. Accordingly, x_{ct} can be provided as x_{ct}=α+(β) x_{c*t}+ϵₜ.

The vector z can further incorporate the statistical relationship between x_{ct} and x_{c*t}, above, according to zₜ=Hₜxₜ+vₜ. More particularly, zₜ can be described as a 3×1 vector including the first and second terms s_{ct} and s_{c*t}, along with a third term of −α. For example:

$${z}_{t} = [ \begin{matrix}{S}_{ct} \\ {S}_{c * t} \\ - α\end{matrix} ] = [ \begin{matrix}1 & 0 \\ 0 & 1 \\ - 1 & β\end{matrix} ] [ \begin{matrix}{x}_{ct} \\ {x}_{c * t}\end{matrix} ] + [ \begin{matrix}{v}_{ct} \\ {v}_{c * t} \\ {ϵ}_{t}\end{matrix} ] .$$

Again, the dimensions and the structure of H are illustrative. A covariance matrix, Rₜ, for the error term v can capture sampling variance (illustratively, as a 3×3 matrix).

The asynchronous engine 104 can estimate an initial condition of x and its variance P prior to an application of a Kalman filter or another recursive statistical technique. For example, an initial state can be described by a known mean xo and variance Po. The asynchronous engine 104 can employ various statistical techniques such as regression or a dynamic technique such as Kalman Filtering to determine asynchronous state data 124 values based on a first portion (e.g., 1-12) times of the time-series data. Upon such determination, the determined asynchronous state data 124 values can be used to augment further predictions. In some cases, the asynchronous engine 104 can update the determined values of the asynchronous state data 124 periodically. For example, the updates can be performed as a background process to avoid introducing latency into a user interface.

The data processing system 100 can include at least one synchronous engine 106 designed, constructed, or operational to determine (e.g., estimate) the latent variable x using asynchronous state data generated by the asynchronous engine 104. The synchronous engine 106 can operate synchronously to a receipt of a selection from the user interface 102, a receipt of data elements 122 of a new time of time-series data, or other inputs. The synchronous engine 106 can operate with low latency (sometimes referred to as real-time or near real-time operation). However, such a nomenclature should not be construed as limiting. In some instances, the synchronous engine 106 can operate prior to a request or display of information, as can further reduce latency. Moreover, in some instances, such as where a computing device is compute-bound, substantial latency may be observable via a user interface.

The synchronous engine 106 can determine (e.g., predict, estimate, or forecast) xₜ and Pₜ based on previous state data. More particularly, xₜ can be predicted as Fₜx_{t-1|t-1}. A corresponding variance can be provided as FₜP_{t-1|t-1}F′ₜ+Qₜ. Thus the synchronous engine 106 estimates a forward time-wise propagation of xₜ and Pₜ.

Moreover, upon a receipt of time-series data for a time of interest, the synchronous engine 106 can determine an update to xₜ and Pₜ based on current time-series data, as augmented by prior time-series data, or other related information. For example, continuing the example of a Kalman filter, a Kalman gain matrix, Kₜ can be provided as:

$$\frac{{P}_{t \vert t - 1} {H}_{t}^{′}}{{H}_{t} {P}_{t \vert t - 1} {H}_{t}^{′} + {R}_{t}} ;$$

x_{t|t} can be provided as:

\hat{x}_{t|t-1}+Kₜ(zₜ−Hₜ\hat{x}_{t|t-1});

P_{t|t} can be provided as:

(I−KₜHₜ)P_{t|t-1′}

where I is (illustratively) a (2×2) identity matrix. This set of equations can provide an estimate of the latent variable x by augmenting current information for a cohort and a time period of interest with information from the same time cohort during other time periods and different cohorts of the same time period.

In some instances, such augmentation is performed for all cases, to use latent information encoded into data other than a cohort from a time of interest of the time-series. In some cases, the augmentation can be performed selectively, such as based on a comparison to a threshold (e.g., a threshold for statistical significance or other confidence interval). For example, where a number of data elements for a cohort and a time of a time-series exceeds a threshold, the operation of the augmentation engine 103 can be omitted, and a centroid can be determined based on a selected time-series alone. For example, where hundreds or thousands of data elements 122 are available for a time and cohort, the data augmentation can be omitted, and a representative value can be determined as an arithmetic mean or other centroid of the available data elements 122. However, in some cases, the systems and methods of the present disclosure can improve determinations of the representative value (e.g., reduce a difference between a ground truth and the representative value), even if adjustments to a centroid are relatively small. Accordingly, in some cases, the augmentation engine 103 can operate for all sample sizes. Moreover, in some cases, operation of the augmentation engine 103 can depend on available compute. For example, a threshold can be provided as a dynamic threshold based on available compute resources. For example, the augmentation engine 103 can operate for sample sizes less than a threshold, and the threshold can be adjusted upward responsive to a lack of available compute resources and downward responsive to idle compute resources.

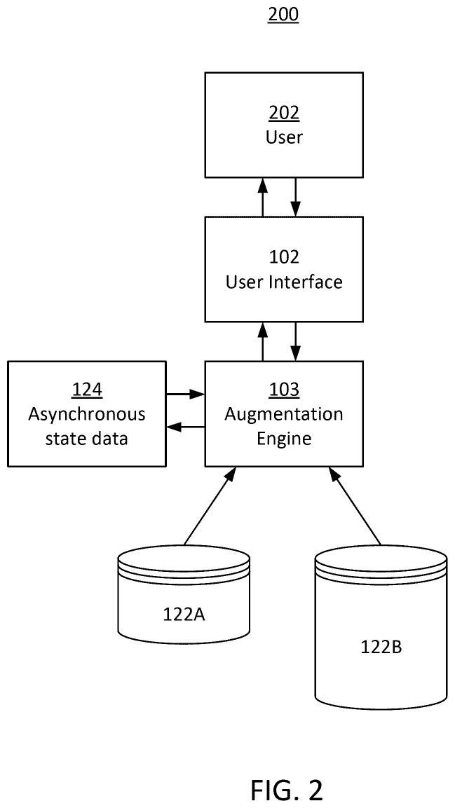

FIG. 2 depicts a dataflow 200 for the data processing system 100 of FIG. 1, in accordance with some aspects. The augmentation engine 103 can receive a first class of data elements 122A, and a second class of data elements 122B. For example, the first class of data elements 122A can include data elements 122 for a selected time, and the second class of data elements 122B can include data elements 122 from previous times of related time-series data. The augmentation engine 103 can aggregate the separate classes of data elements 122 according to an operation of an asynchronous engine 104 coupled with a synchronous engine 106. For example, the augmentation engine 103 can generate asynchronous state data 124, including model parameters for a model of the data elements 122. The augmentation engine 103 can generate or update this asynchronous state data 124 according to a background or other periodic process, such as a nightly process, monthly process, process executed based on a receipt of the first class of data elements 122A, or so forth.

A dashboard of the user interface 102 can provide a number of cohorts for which asynchronous state data 124 is available. Moreover, the dashboard can include selectable control elements configured to receive selections of further cohorts. For example, the user 202 can select a further cohort as can be included into a scheduled process to generate asynchronous state data 124, or to generate asynchronous state data 124 responsive to its selection (e.g., as a one-time operation). Upon an access of or completion of generation of the asynchronous state data 124 generated by the asynchronous engine 104, the dashboard can present further information, as can be generated by the synchronous engine 106.

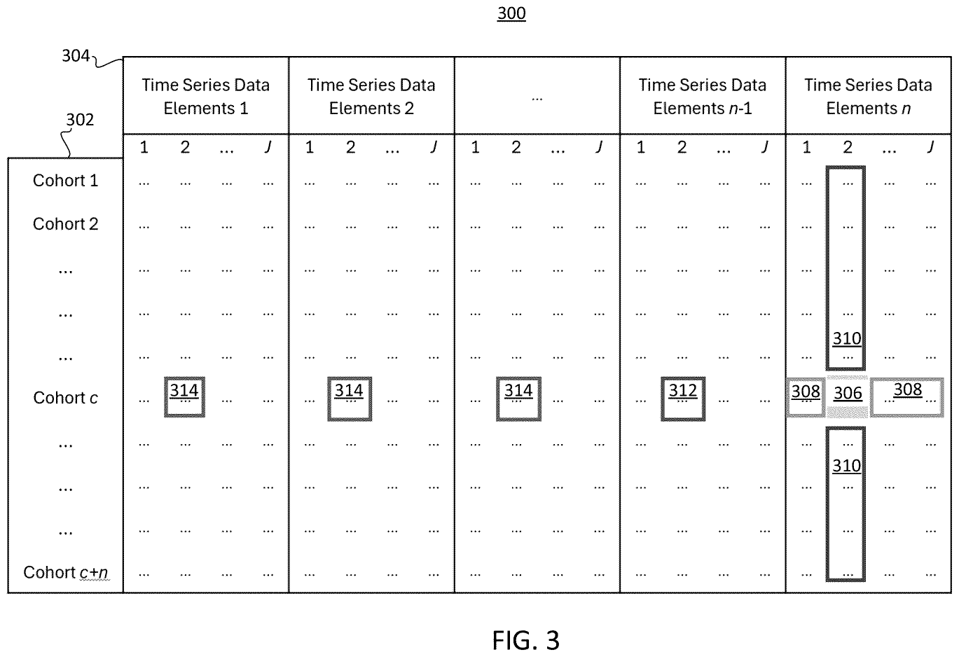

FIG. 3 depicts an example of data structure 300 including time-series data elements 122 related to various cohorts and a time-series sequence 304, in accordance with some aspects. The data structure 300 includes various cohorts 302. The cohorts 302 can overlap with one another (e.g., can share members). For example, a first cohort 302 can include males aged 18-40, a second cohort 302 can include college educated adults, and a third cohort 302 can include residents of Wisconsin. The cohorts 302 can further include non-overlapping cohorts, such as persons aged 18-40 and persons aged 41-55. In some cases, the cohorts 302 can include indications of identity, such as names, advertiser identifications, survey control numbers, or so forth. However, such individuals can sometimes exist in different cohorts 302 over time. For example, a person can correspond to an age 18-40 cohort 302 for one time of the time-series sequence 304 and an age 41-55 cohort 302 for a subsequent time of the time-series sequence 304.

An intersection of a selected cohort 302 (c) and a selected time (n) includes a first class 306 of data elements 122 (e.g., data elements 122A of FIG. 2). For example, these data elements 122 can include survey responses to a question of a survey. The survey responses can include binary or numeric responses (e.g., true/false, agree/disagree, or scales from 1-10). The first class 306 of data elements 122 can be used to determine a centroid. Such centroids can include weighting according to deviation from a mean, exclusion of outliers, and other data transforms, or determined as an algebraic mean of values. However, in some cases, the first class 306 can include fewer data elements than are desired for a statistical confidence. For example, the first class 306 can include zero, three, five, or ten data elements, as can provide limited statistical significance, relative to larger numbers of data elements 122.

The various survey questions (or other data elements 122) can logically correspond to one another. For example, a first survey question can relate to brand trust, and a related survey question can relate to brand safety. Such co-relation can be described as a statistical relationship between x_{ct} and x_{c*t} (e.g., x_{ct}=α+βx_{c*t}+ϵₜ). Accordingly, second class information used to augment the first class 306 information can rely on these related data elements. This second class of information can include, for example, related data elements 308 of the same time interval and cohort 302, related data elements 310 of other cohorts 302 of the same time interval, or related data elements 312, 314 for a same cohort in one or more preceding time intervals of the time-series sequence 304.

The various cohorts 302 can logically correspond to one another. For example, information for a group of persons aged 18-23 and another group of persons aged 29-33 can be predictive of a cohort 302 of interest including persons aged 24-28. Although such a relationship can be predicted according to linear or other interpolation, such an illustrative example should not be construed as limiting. Various cohorts can be related with one-another according to functional forms that can be described (for any one cohort) illustratively as:

$${z}_{t} = [ \begin{matrix}{S}_{ct} \\ {S}_{c * t} \\ - α\end{matrix} ] = [ \begin{matrix}1 & 0 \\ 0 & 1 \\ - 1 & β\end{matrix} ] [ \begin{matrix}{x}_{ct} \\ {x}_{c * t}\end{matrix} ] + [ \begin{matrix}{v}_{ct} \\ {v}_{c * t} \\ {ϵ}_{t}\end{matrix} ] .$$

Accordingly, the augmentation engine 103 can augment available data elements 122 to determine data indicated by a first class 306 of data elements 122. The various times of the time-series data can correspond to one-another. For example, data elements from a previous time (t-1) 312 or prior thereto 314 can aid to determine a representative value for the first class 306 of data elements 122. For example, the asynchronous engine 104 can determine xo and x as a function of t using previous values, to include xₜ₋₁, xₜ₋₂, and so forth. Thereafter, the synchronous engine 106 can determine xₜ as a function of xₜ₋₁ and x_{t|t} (e.g., the synchronous engine 106 can provide x_{t|t} as:

\hat{x}_{t|t-1}+Kₜ(zₜ−H_{tt|t-1})).

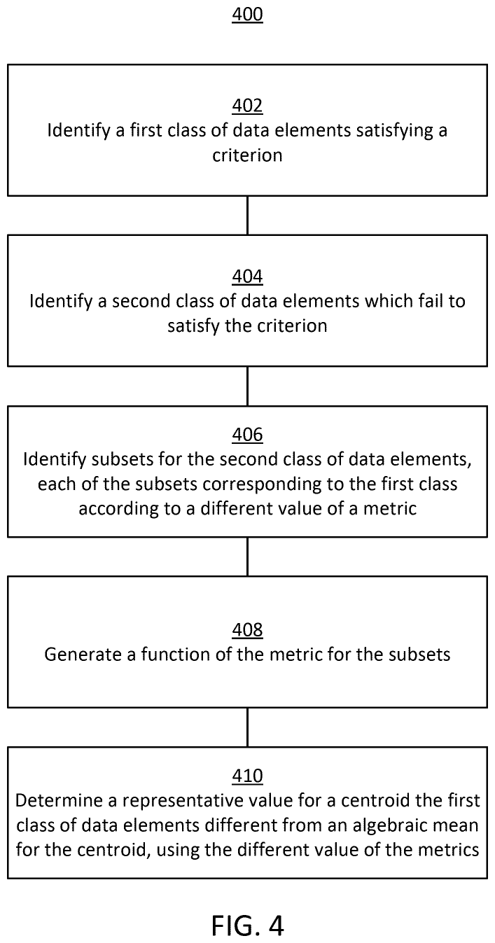

FIG. 4 is a dataflow for a method 400, according to some aspects. The method 400 can be performed by one or more processors, as can be used to implement the data processing system 100 of the present disclosure. The present method 400 should not be construed to limit the present disclosure. For example, operations of the method 400 can be modified, substituted, omitted, or added, according to the various aspects of the present disclosure.

At ACT 402, the data processing system 100 can identify a first class of data elements 122 satisfying a criterion. For example, the criterion can include matching cohort characteristics. For example, the cohort characteristics can include demographic information such as age, income, sex, consumer purchase history, location, or so forth. The criterion can further include a time period for the response, such as within a previous thirty days, within a particular stage of a survey campaign, or so forth. The first class of data elements 122 (e.g., the first class 306 depicted in FIG. 3) can include a subset of data elements 122 disposed in a data lake (e.g., in a data repository 120 of the data processing system 100). The first class of data elements 122 can be determined incident to a selection received from a user interface 102, such as a synchronous selection received from a user 202, or a previously defined selection used to schedule a process to generate asynchronous data.

The second class of data elements 122 can be identified based on a linear relationship to the first class of data elements. For example, the relationship can include age, income, distance from a zip code, a time of time-series data, or so forth. The linearity of the relationship need not correspond to a linear pattern of the data elements themselves. For example, cohorts of varying age, income, or location can respond to surveys according to a non-linearity to that demographic feature, as can be described by any of various curves. In some cases, a curve for the linear relationship terminates at the first class of data elements 122. For example, a linear relationship of various time-series data can terminate at a most recent time; a linear relationship of age can terminate at an oldest or youngest cohort. In some cases, the linear relationship can extend through the first class of data elements (e.g., in two directions). For example, the age relationship extends through all other than an oldest and youngest cohort.

The first class of data elements 122 can include various quantities of data elements 122. In some cases, the first class can include a quantity of zero data elements. Accordingly, the representative value can be based on the second class of data elements 122 alone. In some cases, the first class can include a large quantity of data elements. Accordingly, a representative value can depend principally on the first class, but can include adjustments based on a quantity or correlation of various other data elements 122.

At ACT 404, the data processing system 100 can identify a second class of data elements 122 which fail to satisfy the criterion. For example, the second class of data elements 122 can satisfy a different criterion, related to the first criterion of ACT 402. For example, the second class of data elements 122 can include related data elements 308 of the same time interval and cohort or data elements 310 of related cohorts of the same time interval. That is, the first class of data elements 122 can include data elements for an nth time of time-series data and the second class of data elements can also include time-series data for the nth time. In some instances, the first class of data elements and the second class of data elements correspond to respective inputs of a cohort population (e.g., survey entries). The second class of data elements 122 can include a same cohort in one or more preceding time intervals 312, 314. That is, the first class of data elements 122 can include data elements 122 for an nth time of time-series data, and the second class of data elements can include time-series data for a various (one or more) times preceding the nth time. These are illustrative and the second class can in principle also include time-series data for one or more cohorts different from the first class for one or more preceding time intervals.

In some implementations, the data processing system 100 can identify the second class of data elements 122 according to a predetermined operation. For example, all data elements of a data lake can be identified as a portion of the second class. Such an implementation can include some data elements exhibiting strong correlation to the first class. For example, some of the second data class can be strongly predictive of a representative value for the first data class, and others can be less strongly correlated. In some cases, the data processing system can implement thresholding to exclude data elements having a correlation less than a threshold. In some implementations, the identified data elements 122 of the second class, or their strength of correlation, are identified based on a user selection received via the user interface 102.

In some implementations, the data processing system 100 can identify the second class of data elements 122 based on a quantity of the first class of data elements 122. For example, where a quantity of the first class of data elements 122 exceeds a threshold (as can correspond to a confidence interval or other statistical confidence), ACTs of the method 400 can be omitted or substituted. More particularly, the selection of the second class of data elements 122 itself, or other sub-operations can be omitted such that the representative value of ACT 410 is not determined based on the second class of data elements 122.

At ACT 406, the data processing system 100 can identify, for the second class of data elements 122, a plurality of subsets, each of the plurality of subsets corresponding to the first class according to a different value of a metric. For example, the subsets can include related data elements 122 of a same time of a time-series sequence 304 (e.g., for a same or different cohort 302) or previous times of the time-series sequence 304. The metric can include a scalar multiple for other data for the same time, a relationship between cohorts, or a temporal distance between the second class of data elements 122 and the first class of data elements 122. For example, the temporal distance can refer to a step difference between subsequent times (e.g., t-1). Further temporal information can be encoded according to sequences of addition time (e.g., t-2, t-3, etc.). Such encoded information can include iterative encodings of t-1 for each of the times of the time-series sequence 304.

At ACT 408, the data processing system 100 can generate a function of the metric for the plurality of subsets. For example, a function for time-wise changes can be generated as a transition matrix Fₜ in conjunction with zₜ, Hₜ and the various error variances. Further examples of the metric are provided by various functions as can be executed by the augmentation engine 103.

At ACT 410, the data processing system 100 can determine a representative value for a centroid of the first class of data elements 122 different from an algebraic mean for the centroid, using the different value of the metrics for each of the plurality of subsets of the second class of data elements. For example, for survey data rated from a score of 1-5, the centroid of the first class of data element 122 can refer to an algebraic mean of the scores, such as 3.5. Other data types (e.g., vectors, tensors, etc.) can exhibit centroids of higher dimensionality, such that a centroid can refer to a geometric or other mean. The algebraic mean (e.g., 3.5) can be based on a limited cohort size available in the first class. For example, the algebraic mean can be based on a cohort of ten survey responses, may not consider additional information available for related questions, related cohorts, or previous times of time-series data.

The data processing system 100 can determine the representative value automatically, or in response to a trigger, such as an indication to generate the representative value using the asynchronous state data as received from the user. Such an indication can be received from the user interface subsequent to a presentation of an indication of an availability of asynchronous state data, such as a “ready” indicator, as may provide an indication that the data processing system 100 is ready to determine the representative value.

The representative value can differ from the centroid based on data elements 122 of the second class. For example, if prior averages for the same cohort, other cohorts of the same time, or related questions for the same cohort indicate a score of less than 3.5, the representative value can be adjusted downward from the algebraic mean, according to an operation of the augmentation engine 103. Conversely, if prior averages for the same cohort, other cohorts of the same time, or related questions for the same cohort indicate a score greater than 3.5, the augmentation engine 103 can adjust the representative value upward from the algebraic mean. The representative value can refer to an aspect of the cohort, such as a behavioral prediction (e.g., brand affinity, spending pattern, or so forth).

FIG. 5 is a block diagram illustrating an architecture for a computer system 500 that can be employed to implement elements of the systems and methods described and illustrated herein. The computer system or computing device 500 can include or be used to implement a data processing system 100 or its components, and components thereof. The computing system 500 includes at least one bus 505 or other communication component for communicating information and at least one processor 510 or processing circuit coupled to the bus 505 for processing information. The computing system 500 can also include one or more processors 510 or processing circuits coupled to the bus for processing information. The computing system 500 also includes at least one main memory 515, such as a random-access memory (RAM) or other dynamic storage device, coupled to the bus 505 for storing information, and instructions to be executed by the processor 510. The main memory 515 can be used for storing information during execution of instructions by the processor 510. The computing system 500 can further include at least one read only memory (ROM) 520 or other static storage device coupled to the bus 505 for storing static information and instructions for the processor 510. A storage device 525, such as a solid-state device, magnetic disk or optical disk, can be coupled to the bus 505 to persistently store information and instructions (e.g., for the data repository 120).

The computing system 500 can be coupled via the bus 505 to a display 535, such as a liquid crystal display, or active-matrix display. An input device 530, such as a keyboard or mouse can be coupled to the bus 505 for communicating information and commands to the processor 510. The input device 530 can include a touch screen display 535.

The processes, systems and methods described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement can also be employed to execute the instructions contained in main memory 515. Hard-wired circuitry can be used in place of or in combination with software instructions together with the systems and methods described herein. Systems and methods described herein are not limited to any specific combination of hardware circuitry and software.

Although an example computing system has been described in FIG. 5, the subject matter including the operations described in this specification can be implemented in other types of digital electronic circuitry, or in computer software, firmware, or hardware, including the structures disclosed in this specification and their structural equivalents, or in combinations of one or more of them.

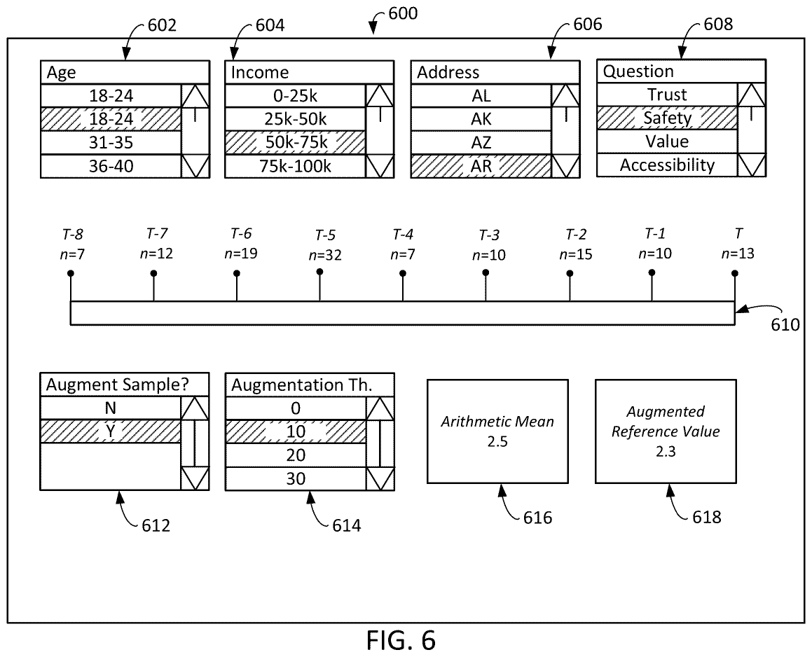

FIG. 6 depicts an example of a graphical user interface (GUI) 600 generated or presented by the user interface 102, according to some aspects. The GUI 600 can present one or more selections of a cohort, such as a first control element 602 to select a cohort according to an age, a second control element 604 to select a cohort according to an income, a third control element 606 to select a cohort according to an address, and so forth. The GUI 600 can present one or more selections of data elements 122 for a cohort. For example, a fourth control element 608 can provide for a selection of various questions from a survey.

According to a selection of the cohort or the further selections of data elements (e.g., based on the fourth control element 608), the GUI 600 can depict further display or control elements. For example, the GUI 600 can depict an indication 610 of a sample size available for one or more times of a time-series sequence. A statistical confidence of each sample can vary according to this sample size (as well as other metrics, such as a deviation from a previous estimated value). For example, a sample size of 32 (as provided at T-5) can exhibit greater statistical confidence than a sample size of 7 (as provided at T-8 and T-4). In some cases, the augmentation engine 103 can augment all (or a subset) of samples. For example, the augmentation engine 103 can augment samples having a sample size less than a threshold. A fifth control element 612 is provided to enable or disable augmentation, as can be provided in some implementations. A sixth control element 614 is provided to adjust an augmentation threshold.

The data processing system 100 can depict an indication 616 of a centroid (e.g., arithmetic mean) for a selected class of data elements 122. The data processing system 100 can depict an augmented reference value 618, as may differ from the indication 616 of the centroid. The depicted indications and control elements should not be construed as limiting. The data processing system 100 can provide an indication of pre-computed asynchronous state data 124, as may be indicative of available real-time operation of the augmentation engine 103 (e.g., of the synchronous engine 106). The GUI 600 can further provide a time to completion of a computation (e.g., of the asynchronous state data 124), or further provide a prompt to add a selected class of data elements 122 to a background or scheduled task for the asynchronous engine 104.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a subject can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

What is claimed is:

1. A system, comprising:
a data processing system comprising one or more processors coupled with memory, the data processing system to:
identify, in a data lake, a first class of data elements satisfying a criterion;
identify, in the data lake, a second class of data elements that fail to satisfy the criterion;
identify, for the second class of data elements, a plurality of subsets, each of the plurality of subsets corresponding to the first class according to a different value of a metric;
generate for the plurality of subsets, a function of the metric;
determine a representative value for a centroid of the first class of data elements different from an algebraic mean for the centroid, using the different value of the metric for each of the plurality of subsets of the second class of data elements and the first class of data elements; and
present, via a graphical user interface, the representative value.

2. The system of claim 1, wherein the metric comprises a temporal distance between the second class of data elements and the first class of data elements.

3. The system of claim 1, wherein:
the first class of data elements corresponds to a first cohort population; and
the second class of data elements corresponds to a second cohort population, different from the first cohort population.

4. The system of claim 1, comprising the data processing system to:
present, via a user interface, an indication of asynchronous state data;
receive, from the user interface, an indication to generate the representative value using the asynchronous state data; and
generate the representative value responsive to the receipt of the indication to generate the representative value.

5. A computer-readable medium comprising instructions, which, when executed by one or more processors, cause the one or more processors to:
receive, from a graphical user interface, an indication to generate a representative value using the asynchronous state data;
responsive to the receipt of the indication:
identify, in a data lake, a first class of data elements satisfying a criterion;
identify, in the data lake, a second class of data elements which fail to satisfy the criterion;
identify, for the second class of data elements, a plurality of subsets, each of the plurality of subsets corresponding to the first class according to a different value of a metric;
generate for the plurality of subsets, a function of the metric; and
determine a representative value for a centroid of the first class of data elements different from an algebraic mean for the centroid, using the different value of the metric for each of the plurality of subsets of the second class of data elements and the first class of data elements; and
present, via the graphical user interface, the representative value.

6. The computer-readable medium of claim 5, wherein the metric comprises a temporal distance between the second class of data elements and the first class of data elements.

7. The computer-readable medium of claim 5, wherein:
the first class of data elements corresponds to a first cohort population; and
the second class of data elements corresponds to a second cohort population, different from the first cohort population.

8. The computer-readable medium of claim 5, wherein the instructions comprise instructions to:
receive, from the user interface, an indication to generate the representative value using the asynchronous state data; and
generate the representative value responsive to the receipt of the indication to generate the representative value.

9. A method, comprising:
identifying in a data lake, by one or more processors, a first class of data elements satisfying a criterion;
identifying in the data lake, by the one or more processors, a second class of data elements which fail to satisfy the criterion;
identifying, by the one or more processors, for the second class of data elements, a plurality of subsets, each of the plurality of subsets corresponding to the first class according to a different value of a metric;
generating for the plurality of subsets, by the one or more processors, a function of the metric; and
determining, by the one or more processors, a representative value for a centroid of the first class of data elements different from an algebraic mean for the centroid, using the different value of the metric for each of the plurality of subsets of the second class of data elements.

10. The method of claim 9, wherein the metric comprises a temporal distance between the second class of data elements and the first class of data elements.

11. The method of claim 9, wherein the representative value is determined based on the first class of data elements.

12. The method of claim 9, wherein the second class of data elements are identified based on a linear relationship to the first class of data elements, wherein a curve of the linear relationship terminates at the first class of data elements.

13. The method of claim 9, wherein the second class of data elements are identified based on a linear relationship to the first class of data elements, wherein a curve for the second class of data elements extends through the first class of data elements in two directions.

14. The method of claim 9, wherein:
the first class of data elements corresponds to a first cohort population;
the second class of data elements corresponds to a second cohort population, different from the first cohort population; and
the representative value is a behavioral prediction for the first cohort population.

15. The method of claim 9, wherein:
the first class of data elements corresponds to a first input of a cohort population; and
the second class of data elements corresponds to a second input of the cohort population.

16. The method of claim 9, comprising:
comparing, by the one or more processors, a quantity of the first class of data elements to a first threshold; and
determining, by the one or more processors, the representative value based on the comparison.

17. The method of claim 9, comprising:
presenting by the one or more processors, via a user interface, an indication of an availability of asynchronous state data;
receiving by the one or more processors, from the user interface, an indication to generate the representative value using the asynchronous state data; and
generating the representative value by the one or more processors responsive to the receipt of the indication to generate the representative value.

18. The method of claim 9, comprising:
determining, by the one or more processors, an initial state of a latent variable of the representative value and a variance thereof; and
determining, by the one or more processors, the representative value at a time of time-series data using the initial state.

19. The method of claim 9, wherein:
the first class of data elements comprise data elements for an nth time of time-series data; and
the second class of data elements comprises time-series data for a plurality of times preceding the nth time.

20. The method of claim 9, wherein:
the first class of data elements comprise data elements for an nth time of time-series data; and
the second class of data elements comprises time-series data for the nth time.
